(19) United States
(12) Patent Application Publication
(10) Pub. No.: US 2015/0153856 A1
(43) Pub. Date: Jun. 4, 2015

(54) TOUCHSCREEN DEVICE AND METHOD OF SENSING TOUCH

(71) Applicant: SAMSUNG ELECTRO-MECHANICS CO., LTD., Suwon (KR)

(72) Inventor: Na Rae PARK, Suwon (KR)

(73) Assignee: SAMSUNG ELECTRO-MECHANICS CO., LTD., Suwon (KR)

(21) Appl. No.: 14/167,399

(22) Filed: Jan. 29, 2014

(30) Foreign Application Priority Data
Dec. 2, 2013 (KR) 10-2013-0148815

(51) Int. Cl. G06F 3/041; G06F 3/01

(52) U.S. Cl. CPC G06F 3/041; G06F 3/017; G06F 2203/04101

(57) ABSTRACT

There are provided a touchscreen device and a method of sensing a touch. The method of sensing a touch may include: calculating valid data values from a panel unit; setting a boundary box around valid data values greater than a predetermined first absolute value among the calculated valid data values; creating positive and negative projection masks for valid data values greater than a second predetermined absolute value among the valid data values within the boundary box; and removing the valid data values within the boundary box based on levels of bit masks of the positive and negative projection masks.

### CROSS-REFERENCE TO RELATED APPLICATION

This application claims the benefit of Korean Patent Application No. 10-2013-0148815, filed on Dec. 2, 2013, with the Korean Intellectual Property Office, the disclosure of which is incorporated herein by reference.

### BACKGROUND

The present disclosure relates to a touchscreen device and a method of sensing a touch.

A touchscreen device, such as a touchscreen or a touch pad, is a data input device attached to a display device so as to provide an intuitive user interface, and has, in recent times, been widely used in various electronic devices such as cellular phones, a personal digital assistants (PDA), and navigation devices. Particularly, as demand for smartphones has increased, touchscreens have been increasingly employed as a touchscreen device that provides various input methods in a limited form factor.

Touchscreens used in a portable device may be mainly divided into resistive type touchscreens and capacitive type touchscreens, depending on the way in which touches are sensed therein. Among these, capacitive type touchscreens have advantages of a relatively long lifespan and ease of implementation of various types of data input gesture and touch, thus having been increasingly employed in employed in electronic devices. The capacitive type touchscreen is especially easy to implement a multi-touch interface compared to the resistive type touchscreen, and thus it is widely used in smartphones and the like.

The capacitive type touchscreen includes a plurality of electrodes having a predetermined pattern and the electrodes define a plurality of nodes in which changes in capacitance is generated by a touch. The nodes deployed on a two-dimensional plane generate changes in self-capacitance or mutual-capacitance by a touch. Coordinates of the touch may be calculated by applying a weighted average method or the like to the change in the capacitance formed at the nodes.

The touchscreen device determines that a touch has occurred if there is a sensing data value above a predetermined threshold value among the acquired sensing data values. If an object such as a coin comes in contact and then is removed, an afterimage, i.e., a ghost touch, is left so that it may be erroneously determined that a valid touch has occurred.

### RELATED ART DOCUMENT

(Patent Document 1) Korean Patent Laid-Open Publication No. 2008-0013638

### SUMMARY

An aspect of the present disclosure may provide a touchscreen device and a method of sensing a touch capable of removing invalid touches caused when an object such as a coin comes in contact in a manner that a boundary box is set around valid data values greater than a first absolute value, positive and negative projection masks are created for valid data values greater than a second absolute value among valid data values within the boundary box, and levels of bit masks of the positive and negative projection masks are determined.

According to an aspect of the present disclosure, a method of sensing a touch may include: calculating valid data values from a panel unit; setting a boundary box around valid data values greater than a predetermined first absolute value among the calculated valid data values; creating positive and negative projection masks for valid data values greater than a second predetermined absolute value among the valid data values within the boundary box; and removing the valid data values within the boundary box based on levels of bit masks of the positive and negative projection masks.

The calculating of the valid data values may include calculating the valid data values by obtaining differences between sensing data values acquired from the panel unit and a predetermined offset value.

The boundary box may have a quadrangular shape enclosing the valid data values greater than the first absolute value at a shortest distance.

The creating of the positive and negative projection masks may include creating positive and negative projection masks by counting positive and negative valid data values greater than the second absolute value among the valid data values within the boundary box in a first direction or a second direction in which the electrodes of the panel unit are arranged.

The creating of the positive and negative projection masks may include creating positive and negative projection masks by counting positive and negative valid data values greater than the second absolute value among the valid data values within the boundary box in first and second directions in which the electrodes of the panel unit are arranged.

The removing of the valid data values within the boundary box may include determining whether levels of all of the bit masks of the negative projection masks are above one.

The removing of the valid data values within the boundary box may include not removing the valid data values within the boundary box if levels of all of the bit masks of the negative projection masks are not above one.

The removing of the valid data values within the boundary box may further include determining whether levels of three or more bit masks including bit masks at both ends of the positive projection masks are above one, if the levels of all of the bit masks of the negative projection masks are above one.

The removing of the valid data values within the boundary box may include not removing the valid data values within the boundary box if the levels of three or more bit masks including bit masks at both ends of the positive projection masks are not above one.

The removing of the valid data values within the boundary box may include removing the valid data values within the boundary box if the levels of three or more bit masks including bit masks at both ends of the positive projection masks are above one.

The first absolute value may be equal to the second absolute value.

According to another aspect of the present disclosure, a touchscreen device may include: a panel unit including rows of first electrodes extending a first direction and columns of second electrodes extending a second direction intersecting the first direction; a sensing circuit unit detecting capacitance formed at intersections of the first electrodes and the second electrodes; a signal conversion unit converting the capacitance into digital sensing data; and an operation unit calculating valid data values from the sensing data, setting a boundary box around valid data values greater than a predetermined first absolute value among the calculated valid data values, and creating positive and negative projection masks including bit masks by projecting the valid data values within the boundary box at least one of first and second directions, the operation unit removing the valid data values within the boundary box based on levels of bit masks of the positive and negative projection masks.

The operation unit may calculate the valid data by obtaining a difference between the sensing data and a predetermined offset value.

The boundary box may have a quadrangular shape enclosing the valid data values greater than the first absolute value at a shortest distance.

The positive and negative projection masks may be created by counting positive and negative valid data values greater than the second absolute value among the valid data values within the boundary box in a first direction or a second direction in which the electrodes of the panel unit are arranged.

The first absolute value may be equal to the second absolute value.

The operation unit may remove the valid data values within the boundary box if levels of all of the bit masks of the negative projection masks are above one and the levels of three or more bit masks including bit masks at both ends of the positive projection masks are above one.

The operation unit may determine at least one of the number of touches, coordinates of the touches, and the type of gesture of the touches applied to the panel unit.

The touchscreen device may further include a driving circuit unit applying driving signals to the plurality of first electrodes.

The capacitance may be generated between an intersection of the plurality of first electrodes and the plurality of second electrodes.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view showing an appearance of an electronic device including a touchscreen device according to an exemplary embodiment of the present disclosure;

FIG. 2 is a view of a panel unit included in a touchscreen device according to an exemplary embodiment of the present disclosure;

FIG. 3 is a cross-sectional view of a panel unit included in a touchscreen device according to an exemplary embodiment of the present disclosure;

FIG. 4 is a diagram illustrating a touchscreen device according to an exemplary embodiment of the present disclosure;

FIG. 5 is a flowchart illustrating a method of sensing a touch according to an exemplary embodiment of the present disclosure; and

FIGS. 6 through 8 are diagrams illustrating a method of sensing a touch according to an exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

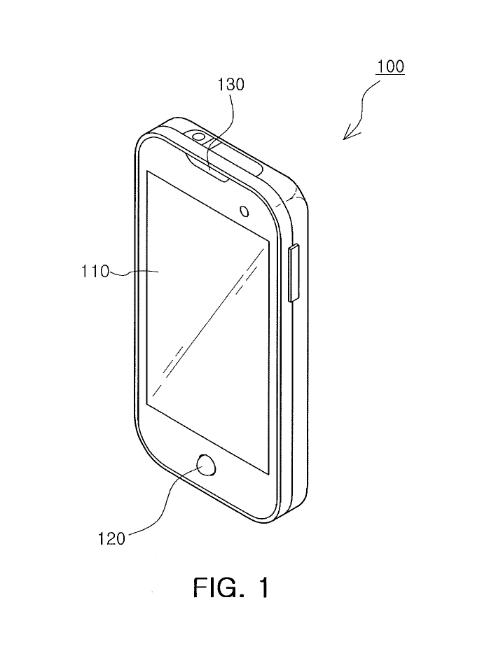

FIG. 1 is a perspective view showing an appearance of an electronic device including a touchscreen device according to an exemplary embodiment of the present disclosure.

Referring to FIG. 1, the electronic device 100 according to the present embodiment may include a display device 110 outputting images on a screen, an input unit 120, an audio unit 130 outputting sound, and a touch sensing device integrated with the display device 110.

As shown in FIG. 1, typically in mobile devices, the touch sensing device is integrated with the display device, and should have a degree of light transmissivity sufficient to allow display images to be seen therethrough. Therefore, the touch sensing device may be implemented by forming a sensing electrode using a transparent and electrically conductive material such as indium tin oxide (ITO), indium zinc oxide (IZO), zinc oxide (ZnO), carbon nanotubes (CNT), or graphene on a base substrate formed of a transparent film material such as polyethylene terephthalate (PET), polycarbonate (PC), polyethersulfone (PES), polyimide (PI), polymethylmethacrylate (PMMA), or the like. The display device may include a wiring pattern disposed in a bezel region thereof, in which the wiring pattern is connected to the sensing electrode formed of the transparent and conductive material. Since the wiring pattern is hidden by the bezel region, it may be formed of a metal material such as silver (Ag) or copper (Cu).

Since it is assumed that the touch sensing device according to the exemplary embodiment of the present disclosure is operated in a capacitive manner, the touchscreen device may include a plurality of electrodes having a predetermined pattern. Further, the touchscreen device may include a capacitance sensing circuit to sense changes in the capacitance generated in the plurality of electrodes, an analog-digital converting circuit to convert an output signal from the capacitance sensing circuit into a digital value, and a calculating circuit to determine if a touch has occurred using the converted digital value.

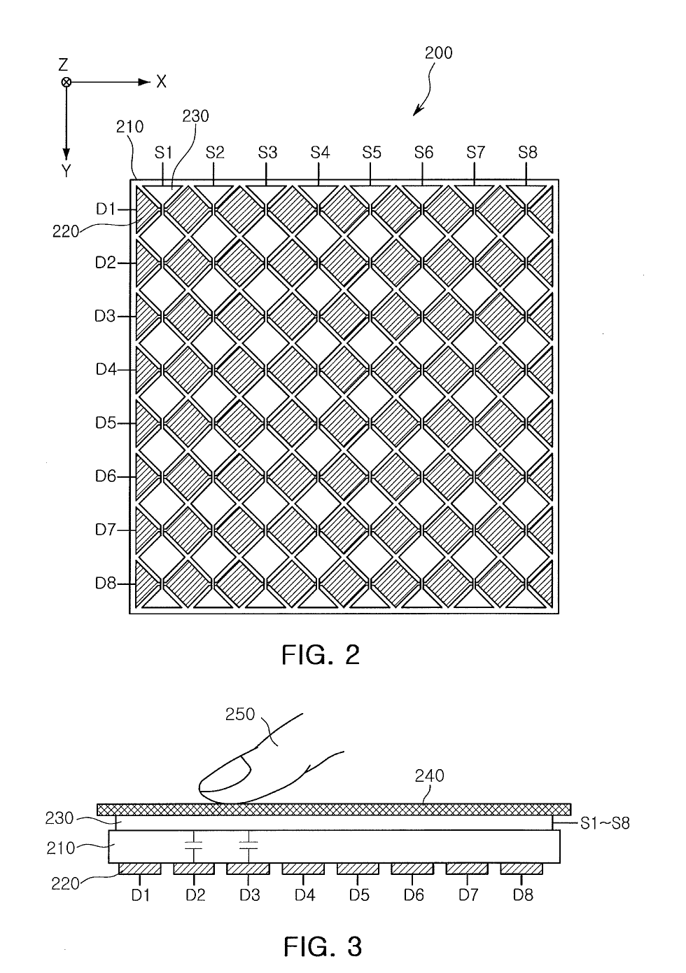

FIG. 2 is a view of a panel unit included in a touchscreen device according to an exemplary embodiment of the present disclosure.

Referring to FIG. 2, the panel unit 200 according to the exemplary embodiment includes a substrate 210 and a plurality of electrodes 220 and 230 provided on the substrate 210. Although not shown in FIG. 2, each of the plurality of electrodes 220 and 230 may be electrically connected to a wiring pattern on a circuit board attached to one end of the substrate 210 through a wiring and a bonding pad. The circuit board may have a controller integrated circuit mounted thereon so as to detect sensing signals generated in the plurality of electrodes 220 and 230 and may determine whether a touch has occurred based on the detected sensing signals.

The plurality of electrodes 220 and 230 may be formed on one surface or both surfaces of the substrate 210. Although the plurality of electrodes 220 and 230 are shown to have a lozenge- or diamond-shaped pattern in FIG. 2, it is apparent that the plurality of electrodes 220 and 230 may have a variety of polygonal shapes such as rectangular and triangular shapes.

The plurality of electrodes 220 and 230 may include first electrodes 220 extending in the x-axis direction, and second electrodes 230 extending in the y-axis direction. The first electrodes 220 and the second electrodes 230 may be provided on both surfaces of the substrate 210 or may be provided on different substrates 210 such that they may intersect with each other. If all of the first electrodes 220 and the second electrodes 230 are provided on one surface of the substrate 210, an insulating layer may be partially formed at intersection points between the first electrodes 220 and the second electrodes 230.

On the regions in which wirings connecting to the plurality of electrodes 220 and 230 are provided in a region other than the region in which the plurality of electrodes 220 and 230 are formed, a printed region may be formed on the region of the substrate 210 so as to hide the wiring typically formed of an opaque metal material.

A device, which is electrically connected to the plurality of electrodes 220 and 230 to sense a touch, detects changes in capacitance generated in the plurality of electrodes 220 and 230 by a touch to sense the touch based on the detected change in capacitance. The first electrodes 220 may be connected to channels defined as D1 to D8 in the controller integrated circuit to receive predetermined driving signals, and the second electrodes 230 may be connected to channels defined as S1 to S8 to be used by the touch sensing device to detect a sensing signal. Here, the controller integrated circuit may detect changes in mutual-capacitance generated between the first and second electrodes 220 and 230 as the sensing signal, in a such manner that the driving signals are sequentially applied to the first electrodes 220 and changes in the capacitance is simultaneously detected from the second electrodes 230.

FIG. 3 is a cross-sectional view of a panel unit included in a touchscreen device according to an exemplary embodiment of the present disclosure. FIG. 3 is a cross-sectional view of the panel unit 200 illustrated in FIG. 2 taken on the y-z plane, in which the panel unit 200 may further include a cover lens 240 that is touched, in addition to the substrate 210 and the plurality of sensing electrodes 220 and 230 described above. The cover lens 240 is provided on the second electrodes 230 used in detecting sensing signals, to receive a touch from a touching object 250 such as a finger.

When driving signals are sequentially applied to the first electrodes 220 through the channels D1 to D8, mutual-capacitance is generated between the first electrodes 220, to which the driving signals are applied, and the second electrodes 230. When the driving signals are sequentially applied to the first electrodes 220, changes in the mutual-capacitance has occurred between the first electrode 220 and the second electrode 230 close to the area with which the touching object 250 comes in contact. The change in the mutual-capacitance may be proportional to the overlapped area between the region that the touching object 250 comes into contact, and the region that the first electrodes 220, to which the driving signals are applied, and the second electrodes 230. In FIG. 3, the mutual-capacitance generated between the first electrodes 220 connected to channel D2 and D3, respectively, and the second electrodes 230 is influenced by the touching object 250.

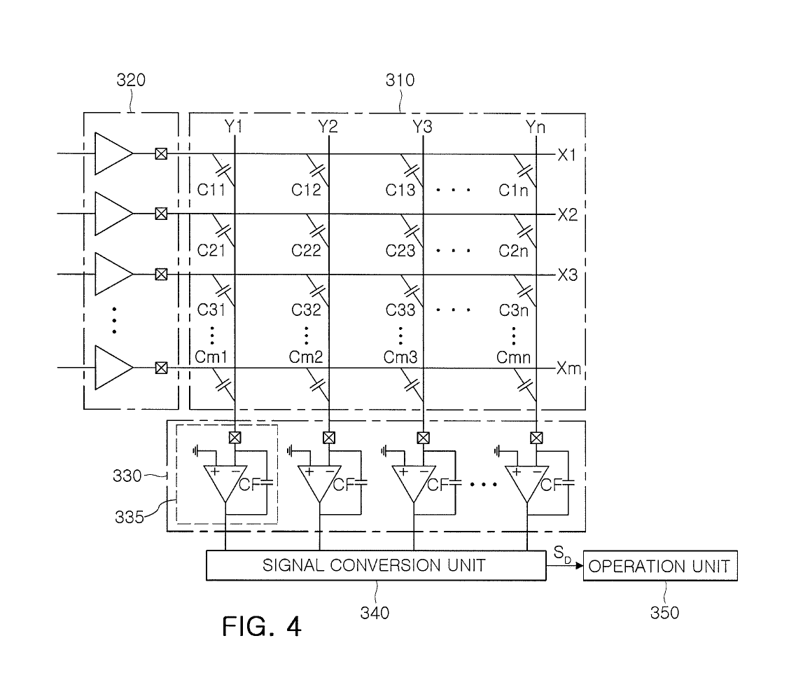

FIG. 4 is a diagram illustrating a touchscreen device according to an exemplary embodiment of the present disclosure.

Referring to FIG. 4, the touchscreen device according to the exemplary embodiment may include a panel unit 310, a driving circuit unit 320, a sensing circuit unit 330, a signal conversion unit 340, and an operation unit 350. The driving circuit unit 320, the sensing circuit unit 330, the signal conversion unit 340, and the operation unit 350 may be implemented as a single integrated circuit (IC).

The panel unit 310 may include rows of first electrode X1 to Xm extending in a first axis direction (that is, the horizontal direction of FIG. 4), and columns of second electrodes Y1 to Yn extending in a second axis direction (that is, the vertical direction of FIG. 4) crossing the first axis direction. Node capacitors C11 to Cmn are the equivalent representation of mutual capacitance generated at intersections of the first electrodes X1 to Xm and the second electrodes Y1 to Yn.

The driving circuit unit 320 may apply predetermined driving signals to the first electrodes X1 to Xm of the panel unit 310. The driving signals may be square wave signals, sine wave signals, triangle wave signals or the like having a specific frequency and an amplitude and may be sequentially applied to the plurality of first electrodes. Although FIG. 4 illustrates that circuits for generating and applying the driving signals are individually connected to the plurality of first electrodes, it is apparent that a single driving signal generating circuit may be used to apply the driving signals to the plurality of first electrodes by employing a switching circuit. In addition, the driving circuit unit 320 may apply driving signals to all of the first electrodes simultaneously or to only some of the first electrodes selectively, to simply determine whether a touch has occurred.

The sensing circuit unit 330 may detect capacitance of the node capacitors C11 to Cmn from the second electrodes Y1 to Yn. The sensing circuit unit 330 may include C-V converters, each of which has at least one operation amplifier and at least one capacitor and is connected to the respective second electrodes Y1 to Yn.

The C-V converters 335 may convert the capacitance of the node capacitors C11 to Cmn into voltage signals so as to output analog signals. For example, each of the C-V converters 335 may include an integration circuit to integrate capacitance values. The integration circuit may integrate and convert capacitance values into a voltage value to output it.

Although the C-V converter 335 shown in FIG. 4 has the configuration in which a capacitor CF is disposed between the inverted input and the output of an operation amplifier, it is apparent that the circuit configuration may be altered. Moreover, each C-V converter 335 shown in FIG. 4 has one operational amplifier and one capacitor, and a plurality of operational amplifiers and capacitors may be provided.

When driving signals are sequentially applied to the first electrodes X1 to Xm, capacitance may be detected simultaneously from the second electrodes, the number of required C-V converts 335 is equal to the number of the second electrodes Y1 to Yn, i.e., n.

The signal conversion unit 340 may generate digital signals S_{D} from the analog signals output from the sensing circuit unit 330. For example, the signal converting unit 340 may include a time-to-digital converter (TDC) circuit measuring a time in which the analog signals in the form of voltage output from the sensing circuit unit 330 reach a predetermined reference voltage level to convert the measured time into the digital signal S_{D}, or an analog-to-digital converter (ADC) circuit measuring an amount by which a level of the analog signals output from the sensing circuit unit 330 is changed for a predetermined time to convert the changed amount into the digital signal S_{D}.

The operation unit 350 may determine whether a touch has occurred on the panel unit 310 based on the digital signal S_{D}. The operation unit 360 may determine the number of touches, coordinates of the touches, and the type of gesture of the touches or the like on the panel unit 310, based on the digital signal S_{D}.

The digital signal S_{D}, which is used by the operation unit 350 to determine whether a touch has occurred, may be data that is a numerical value representing changes in capacitance of the capacitors C11 to Cmn, especially representing a difference between the capacitance with and without a touch. Typically in a capacitive type touchscreen device, a region touched by a conductive object has less capacitance than other regions not touched.

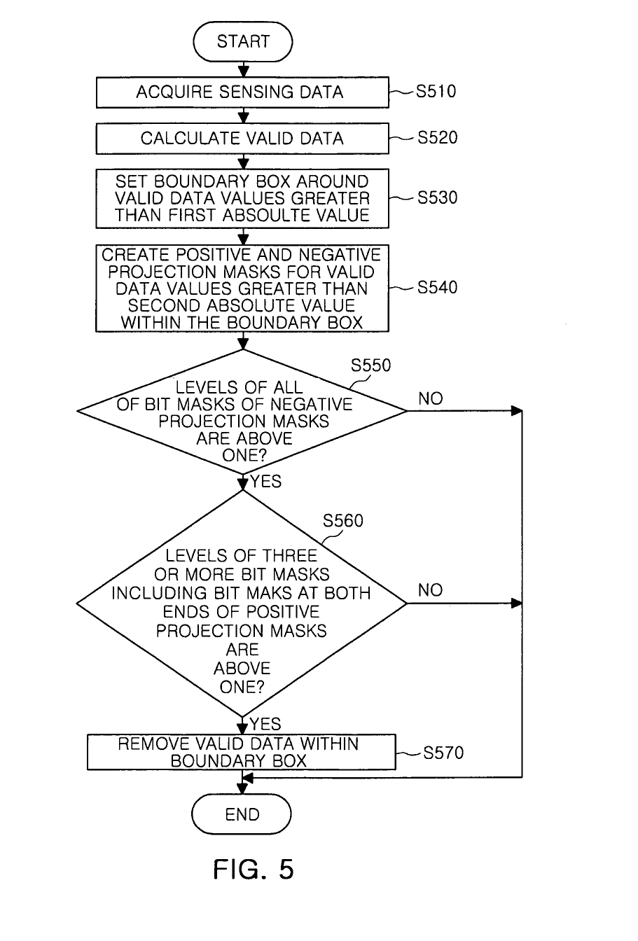

FIG. 5 is a flowchart illustrating a method of sensing a touch according to an exemplary embodiment of the present disclosure.

Referring to FIGS. 4 and 5, the method of sensing a touch according to the exemplary embodiment may start with acquiring sensing data (S510). The driving circuit unit 320 may sequentially apply driving signals to the plurality of first electrodes to acquire sensing data. The sensing circuit unit 330 may detect changes in capacitance from the second electrodes intersecting the first electrodes to which the driving signals are applied. The sensing circuit unit 330 may detect changes in capacitance as an analog signal using the integration circuit, and the analog signal output from the sensing circuit unit 330 may be converted into a digital signal S_{D} by the signal conversion unit 340. The operation unit 350 may determine whether a touch has occurred using the digital signal S_{D} as sensing data.

Upon acquiring the sensing data, the operation unit 350 may subtract an offset value from the sensing data to calculate valid data values (S520). The offset value may be determined from valid data values calculated when no touch has occurred.

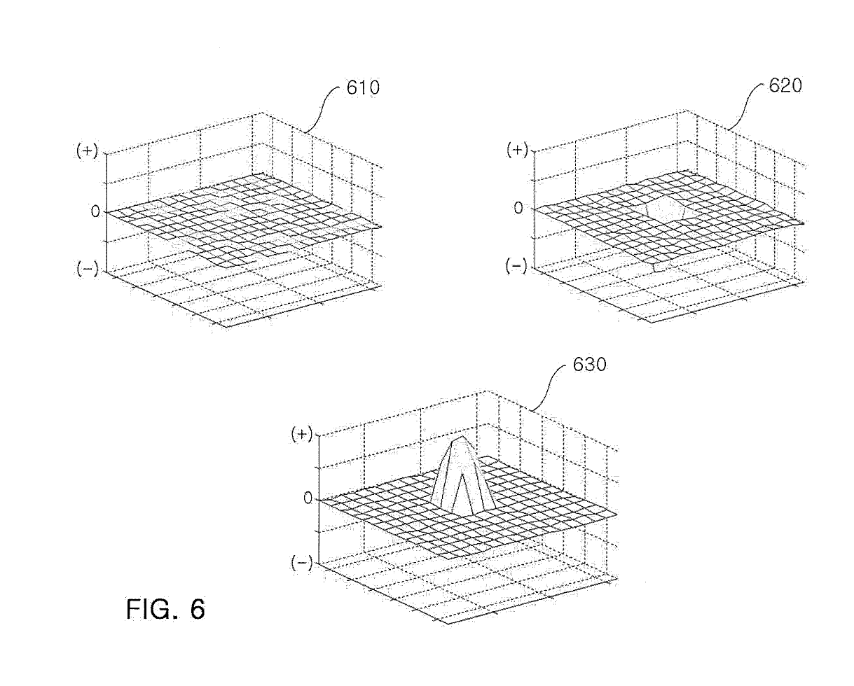

FIGS. 6A through 8 are diagrams illustrating a method of sensing a touch according to an exemplary embodiment of the present disclosure.

Referring to FIG. 6, three graphs are shown. The first graph 610 shows sensing data when no user's touch has occurred. The data shown in the first graph 610 may be set as an offset value.

The second graph 620 shows sensing data that is acquired when a user's touch is made. As described above, if a conductive object such as a finger comes in contact with the panel unit 310, capacitance moves to the conductive object and in turn the data value is reduced around a region with which the conductive object is in contact, such that sensing data is acquired.

The third graph 630 shows valid data that is calculated by subtracting the second graph 620, i.e., the sensing data, from the first graph 610, i.e., the offset value. The operation unit 350 may determine that a touch has occurred if there is a valid data value greater than a predetermined threshold value among the valid data values.

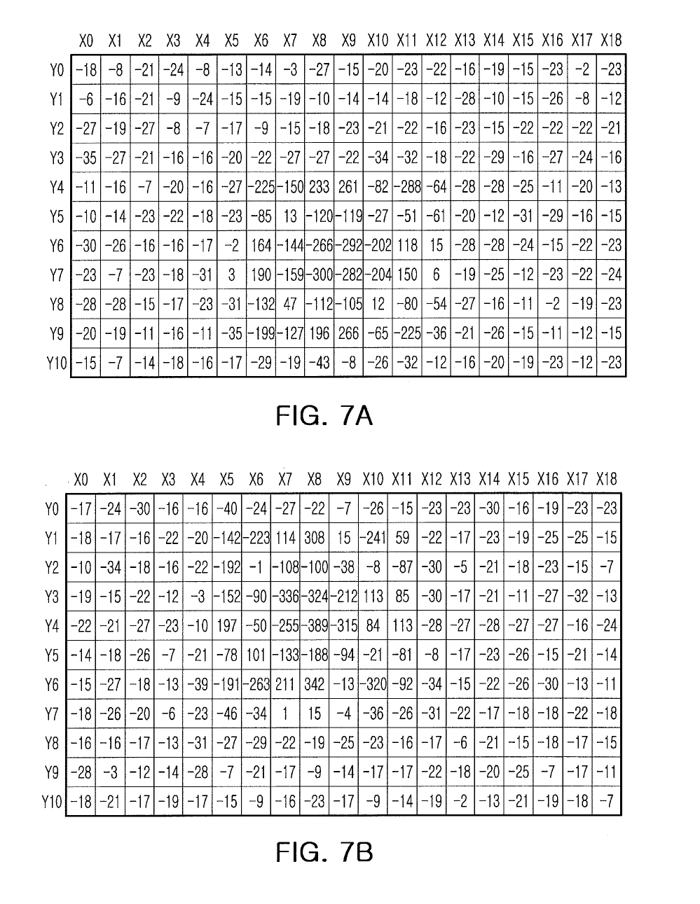

If a valid input has occurred on the panel unit 510 such as when a finger or a stylus pen comes in contact therewith, valid data values distributed in the positive (+) region may be acquired as shown in the third graphs 630 in FIG. 6. On the other hand, if an object such as a coin is placed on the panel unit 510, many valid data values are acquired which are distributed in the positive and negative regions as shown in FIGS. 7A and 7B.

FIGS. 7A and 7B will be described in detail. Assuming that there are eighteen first electrodes X1 to X18 and ten second electrodes Y1 to Y10 in FIG. 4, the valid data value as shown in FIGS. 7A and 7B may be obtained from nodes between the first electrodes X1 to X18 and the second electrodes Y1 to Y10. Looking into the valid data values shown in FIG. 7A which are acquired from the nodes between the sixth to the eleventh ones X6 to X11 of the first electrodes and the fourth to the ninth ones Y4 to Y9 of the second electrodes, and the valid data values shown in FIG. 7B which are acquired from the nodes between the fifth to tenth ones X5 to X10 of the first electrodes and the first to the sixth ones Y1 to Y6 of the second electrodes, it is noted that many positive and negative valid data values having an absolute value of 100 or greater are distributed. Such regions in which many positive and negative valid data values are distributed correspond to regions touched by a coin or the like, not regions in which a valid touch has occurred by a finger or a stylus pen. Therefore, it is necessary to remove the valid data values acquired from the nodes.

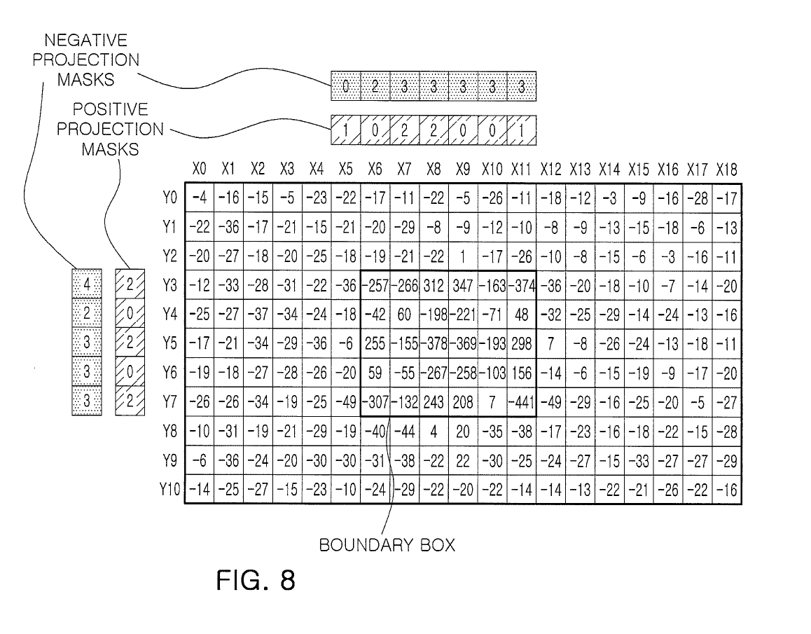

Referring back to FIG. 5, the operation unit 350 may set a boundary box around the valid data values having a first absolute value or greater (S530). The boundary box refers to a quadrangle enclosing the valid data values greater than the first absolute value at the shortest distance. Referring to FIG. 8, a boundary box is set with the first absolute value of 100.

Then, the operation unit 350 may create positive and negative projection masks by projecting valid data values within the boundary box (S540). In this regard, the projecting means counting the valid data values greater than a second absolute value in at least one of first and second directions, i.e., the horizontal and vertical directions. The projection mask may include a plurality of bit masks each corresponding to the respective electrodes. The number of positive valid data values greater than the second absolute value may be marked on the positive projection masks, and the number of negative valid data values greater than the second absolute value may be marked on the negative projection masks. Here, the first absolute value may be equal to the second absolute value.

When projecting onto the valid data values as shown in FIG. 8 is performed, the positive and negative projection masks as shown may be created. Referring to FIG. 8, the operation unit 350 may create two positive masks and two negative masks. According to this exemplary embodiment, it will be appreciated that all of the two positive masks and the two negative masks may be used or one positive mask and one negative mask created by projecting in the first and second direction, respectively, may be used for performing the method of sensing a touch.

After creating the positive and negative masks, the operation unit 350 may determine whether levels of all of the bit masks of the negative masks are above one (S550). If levels of the entirety bit masks of the negative projection masks are not above one, it is determined that no invalid touch, for example, by a coin has occurred, thereby ending the algorithm. On the other hand, if levels of all of the bit masks of the negative projection masks are above one, it is determined whether levels of three or more bit masks including bit masks at both ends of the positive projection masks are above one (S560).

If levels of three or more bit masks including bit masks at both ends of the positive projection masks are above one, it is determined that an invalid touch has occurred, thereby removing valid data in the boundary box (S570). If levels of less than three bit masks including bit masks at both ends of the positive projection masks are above one, it is determined that no invalid touch has occurred, thereby ending the algorithm.

As set forth above, according to exemplary embodiments of the present disclosure, invalid touches caused when an object such as a coin comes in contact may be effectively removed in a manner that a boundary box is set around valid data values greater than a first absolute value, positive and negative projection masks are created for valid data values greater than a second absolute value among valid data values within the boundary box, and levels of bit masks of the positive and negative projection masks are determined.

While exemplary embodiments have been shown and described above, it will be apparent to those skilled in the art that modifications and variations could be made without departing from the spirit and scope of the present disclosure as defined by the appended claims.

What is claimed is:

1. A method of sensing a touch, the method comprising:
calculating valid data values from a panel unit;
setting a boundary box around valid data values greater than a predetermined first absolute value among the calculated valid data values;
creating positive and negative projection masks for valid data values greater than a predetermined second absolute value among the valid data values within the boundary box; and
removing the valid data values within the boundary box based on levels of bit masks of the positive and negative projection masks.

2. The method of claim 1, wherein the calculating of the valid data values includes calculating the valid data values by obtaining differences between sensing data values acquired from the panel unit and a predetermined offset value.

3. The method of claim 1, wherein the boundary box has a quadrangular shape enclosing the valid data values greater than the first absolute value at a shortest distance.

4. The method of claim 1, wherein the creating of the positive and negative projection masks includes creating positive and negative projection masks by counting positive and negative valid data values greater than the second absolute value among the valid data values within the boundary box in a first direction or a second direction in which the electrodes of the panel unit are arranged.

5. The method of claim 1, wherein the creating of the positive and negative projection masks includes creating positive and negative projection masks by counting positive and negative valid data values greater than the second absolute value among the valid data values within the boundary box in first and second directions in which the electrodes of the panel unit are arranged.

6. The method of claim 1, wherein the removing of the valid data values within the boundary box includes determining whether levels of all of the bit masks of the negative projection masks are above one.

7. The method of claim 6, wherein the removing of the valid data values within the boundary box includes not removing the valid data values within the boundary box, if levels of all of the bit masks of the negative projection masks are not above one.

8. The method of claim 6, wherein the removing of the valid data values within the boundary box further includes determining whether levels of three or more bit masks including bit masks at both ends of the positive projection masks are above one, if the levels of all of the bit masks of the negative projection masks are above one.

9. The method of claim 8, wherein the removing of the valid data values within the boundary box includes not removing the valid data values within the boundary box, if the levels of three or more bit masks including bit masks at both ends of the positive projection masks are not above one.

10. The method of claim 8, wherein the removing of the valid data values within the boundary box includes removing the valid data values within the boundary box, if the levels of three or more bit masks including bit masks at both ends of the positive projection masks are above one.

11. The method of claim 1, wherein the first absolute value is equal to the second absolute value.

12. A touchscreen device, comprising:
a panel unit including rows of first electrodes extending a first direction and columns of second electrodes extending a second direction intersecting the first direction;
a sensing circuit unit detecting capacitance formed at intersections of the first electrodes and the second electrodes;
a signal conversion unit converting the capacitance into digital sensing data; and
an operation unit calculating valid data values from the sensing data, setting a boundary box around valid data values greater than a predetermined first absolute value among the calculated valid data values, and creating positive and negative projection masks including bit masks by projecting the valid data values within the boundary box at least one of first and second directions,
the operation unit removing the valid data values within the boundary box based on levels of bit masks of the positive and negative projection masks.

13. The touchscreen device of claim 12, wherein the operation unit calculates the valid data by obtaining a difference between the sensing data and a predetermined offset value.

14. The touchscreen device of claim 12, wherein the boundary box has a quadrangular shape enclosing the valid data values greater than the first absolute value at a shortest distance.

15. The touchscreen device of claim 12, wherein the positive and negative projection masks are created by counting positive and negative valid data values greater than the second absolute value among the valid data values within the boundary box in a first direction or a second direction in which the electrodes of the panel unit are arranged.

16. The touchscreen device of claim 15, wherein the first absolute value is equal to the second absolute value.

17. The touchscreen device of claim 12, wherein the operation unit removes the valid data values within the boundary box, if levels of all of the bit masks of the negative projection masks are above one and the levels of three or more bit masks including bit masks at both ends of the positive projection masks are above one.

18. The touchscreen device of claim 12, wherein the operation unit determines at least one of the number of touches, coordinates of the touches, and the type of gesture of the touches applied to the panel unit.

19. The touchscreen device of claim 12, further comprising a driving circuit unit applying driving signals to the plurality of first electrodes.

20. The touchscreen device of claim 12, wherein the capacitance is formed between intersections of the plurality of first electrodes and the plurality of second electrodes.
